(19) United States
(12) Patent Application Publication
(10) Pub. No.: US 2011/0173972 A1
(43) Pub. Date: Jul. 21, 2011

(54) Internal Combustion Engine Cylinder Head With Integral Exhaust Ducting And Turbocharger Housing

(76) Inventors: Robert Andrew Wade, Dearborn, MI (US); Todd Jay Brewer, Dearborn, MI (US); Jonathan Patrick Jeffries, Canton, MI (US)

(21) Appl. No.: 12/814,524

(22) Filed: Jun. 14, 2010

(51) Int. Cl. F02D 23/00; F01N 1/00; F01N 5/04; F02F 1/42; F02B 75/22; F02F 1/10

(52) U.S. Cl. 60/602; 60/324; 60/280; 123/193.5; 123/54.4; 123/41.72

(57) ABSTRACT

An internal combustion engine cylinder head is based upon a one-piece structure including a number of exhaust runners, an exhaust collector, and a turbocharger exhaust turbine housing, all formed as one-piece.

### TECHNICAL FIELD

The present disclosure relates to an internal combustion engine cylinder head configured as a one-piece structure having integral exhaust ducting and an integral exhaust turbine housing for a turbocharger.

### BACKGROUND

Turbocharging has grown increasingly important in automotive engineering, due to the ability of turbocharging to increase the specific power output of engines without appreciably increasing weight and package volume. An important turbocharger performance attribute is achievable when a given turbocharger is as small as is practicable, assuring that the turbocharger responds promptly to increases in engine load. Of course, minimization of turbocharger system cost is another measure of success. Known turbocharging systems utilize separate components for the cylinder head, exhaust collector, and turbocharger exhaust turbine housing, and this conventional practice increases cost, weight, system package volume, and turbocharger response time.

It would be desirable to provide an internal combustion engine cylinder head configured as one-piece structure, such as a casting, and including integral exhaust ducting and an integral exhaust turbine housing for a turbocharger.

### SUMMARY

According to an aspect of the present disclosure, an internal combustion engine includes a number of power cylinders, and a cylinder head attached to the power cylinders. The cylinder head is configured as a one-piece base structure including: (1) a number of exhaust runners conducting exhaust gases from the power cylinders; (2) an exhaust collector merging exhaust gases flowing through the exhaust runners; (3) a wastegate and exhaust outlet; and (4) an integral turbocharger turbine housing extending through a wall of the exhaust collector. In other words, the hot side of the turbocharger is one-piece with the remaining portions of the cylinder head.

According to another aspect of the present disclosure, an internal combustion engine further includes an exhaust turbine located within an integral turbine housing, and a charge air compressor coupled with the exhaust turbine upon a common rotating shaft.

It is an advantage of a cylinder head system according to the present disclosure that precious space is conserved within the crowded confines of an engine compartment, particularly of an automotive vehicle.

It is another advantage of a cylinder head system according to the present disclosure that exhaust energy is conserved because of the close coupling provided by the present system between the engine's cylinders and the exhaust turbine. This close coupling also reduces turbocharger response time.

It is yet another advantage of the present cylinder head system that the cost of a turbocharged engine is lessened because a separate exhaust manifold and turbine housing, including additional seals and fasteners, are no longer required.

Other advantages, as well as features of the present system, will become apparent to the reader of this specification.

### DESCRIPTION OF DRAWINGS

FIG. 1 is a partially schematic perspective view of an engine having a cylinder head system according to an aspect of the present disclosure.

FIG. 2 is a perspective view of a portion of the engine shown in FIG. 1.

FIG. 3 is a partial section of an engine showing a turbocharger exhaust turbine housing according to an aspect of the present disclosure.

FIG. 4 is a plan view of a turbine housing portion of a cylinder head according to the present disclosure, showing a coolant passage with particularity.

FIG. 5 shows a turbocharger mounted with its center axis parallel to a longitudinal centerline of an engine.

FIG. 6 is a sectional view of the turbocharger and cylinder head of FIG. 5.

FIG. 7 is a perspective view of a pair of turbochargers mounted in the valley area of a V-block engine according to an aspect of the present disclosure.

FIG. 8 is similar to FIG. 7, but shows a different turbocharger orientation.

### DETAILED DESCRIPTION

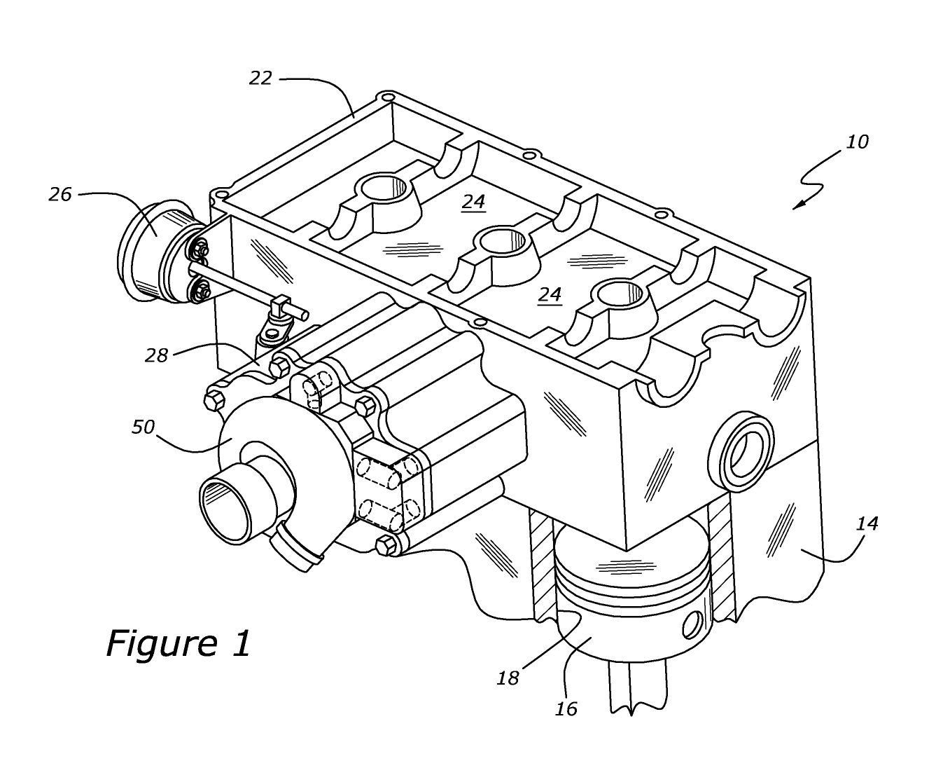

As shown in FIG. 1, engine 10 has a cylinder block, 14, with a number of power cylinders, 18, which house pistons, 16. Those skilled in the art will appreciate in view of this disclosure that engines with other numbers of cylinders could employ a cylinder head and turbocharger system according to the present disclosure. Moreover, the present cylinder head system is equally useful with both V-block and inline type engines, as well as flat or “pancake” type engines.

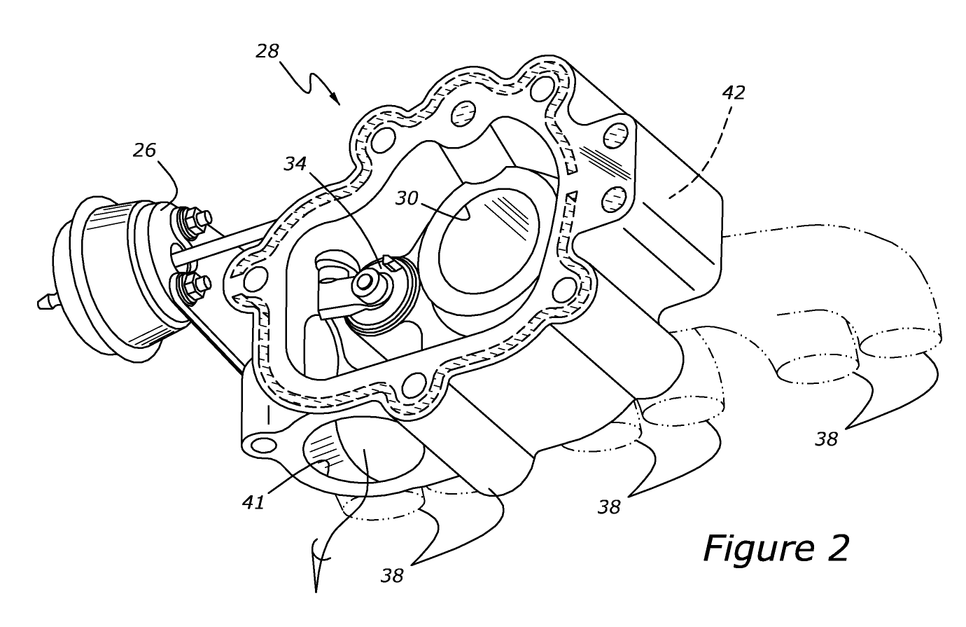

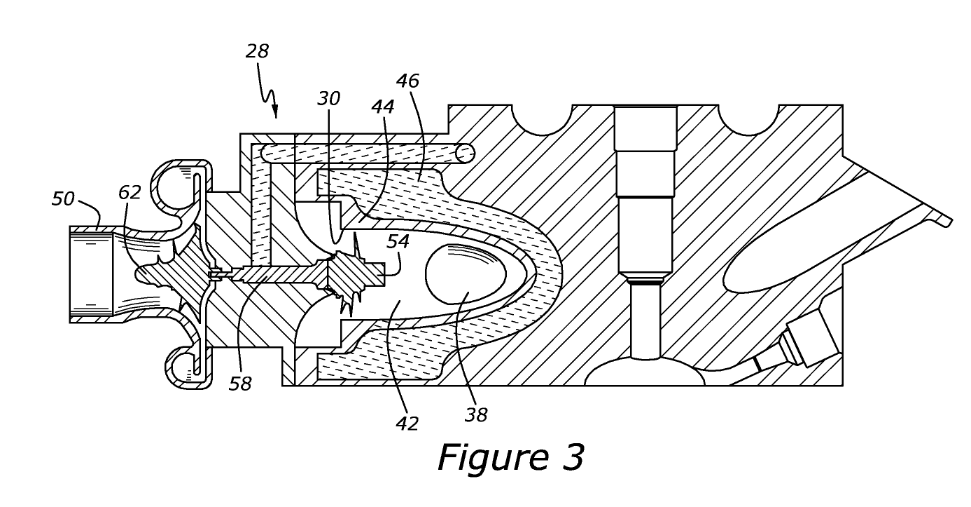

FIG. 1 also illustrates a cylinder head, 22, which incorporates a number of design features within a single cast or machined structure. More specifically, FIG. 1 shows turbocharger hot side, 28, which is also shown in FIGS. 2, 3, and 4. Exhaust turbine housing 30, which is shown in FIGS. 2, 3, and 4, is located within hot side 28 and is one-piece with not only exhaust collector 42 (FIG. 3), but also with a number of exhaust runners, 38 (FIG. 2), which conduct exhaust gases from power cylinders 18.

Exhaust runners 38 discharge into an exhaust collector, 42, (FIG. 3), which merges the exhaust gases and offers them to the turbocharger's exhaust turbine, 54. As shown in FIG. 2, pressure within exhaust collector 42 is controlled by wastegate valve 34. Exhaust leaves through exhaust outlet 41 (FIG. 2), which conducts exhaust gases from the turbocharger's turbine housing to an exterior portion of cylinder head 22. In other words, an exhaust system would be attached to cylinder head 22 at exhaust outlet 41. Thus, cylinder head 22 contains two additional items—wastegate, and a turbocharger exhaust outlet, which are not incorporated in known cylinder heads.

Exhaust collector 42 has an outer wall, 44, with turbine housing 30 formed therein. Thus, turbine housing 30 is one-piece with exhaust collector 42, as well as with exhaust runners 38 and cylinder closure portions 24 of cylinder head 22 (FIG. 1). FIG. 3 also shows a forward facing axial flow exhaust turbine, 54, which is coupled to charge air compressor wheel 62 upon a common rotating shaft, 58.

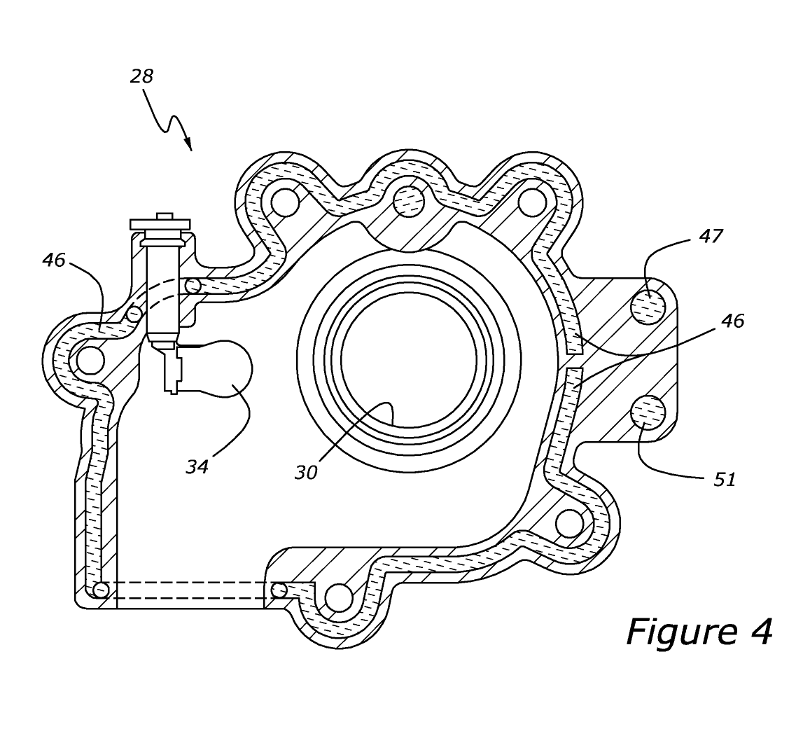

FIG. 4 shows a coolant passage, 46, which extends about the periphery of turbine housing 30. In most cases, engine coolant will be circulated through passage 46 to maintain housing 30 at an acceptable temperature. Coolant passage 46 is key to effectively managing heat flowing through hot section 28 so that the hot section may be one-piece with the remaining portion of the cylinder head. Passage 46 is connected with at least one other cooling passage extending within cylinder head 22. FIG. 4 shows coolant passages 47 and 51, which communicate with passage 46.

Those skilled in the art will appreciate in view of this disclosure that cylinder head 22, including runners 38, collector 42, and turbine housing 30, as well as the more traditional cylinder head structural elements of cylinder head 22, may be configured from either a single metallic or non-metallic or composite casting, such as from aluminum or ferrous material, or at least partially machined from billet. In either case, the advantages of the present system result from the one-piece configuration of the cylinder head, including all of the exhaust piping and hot side 28 of the turbocharger housing.

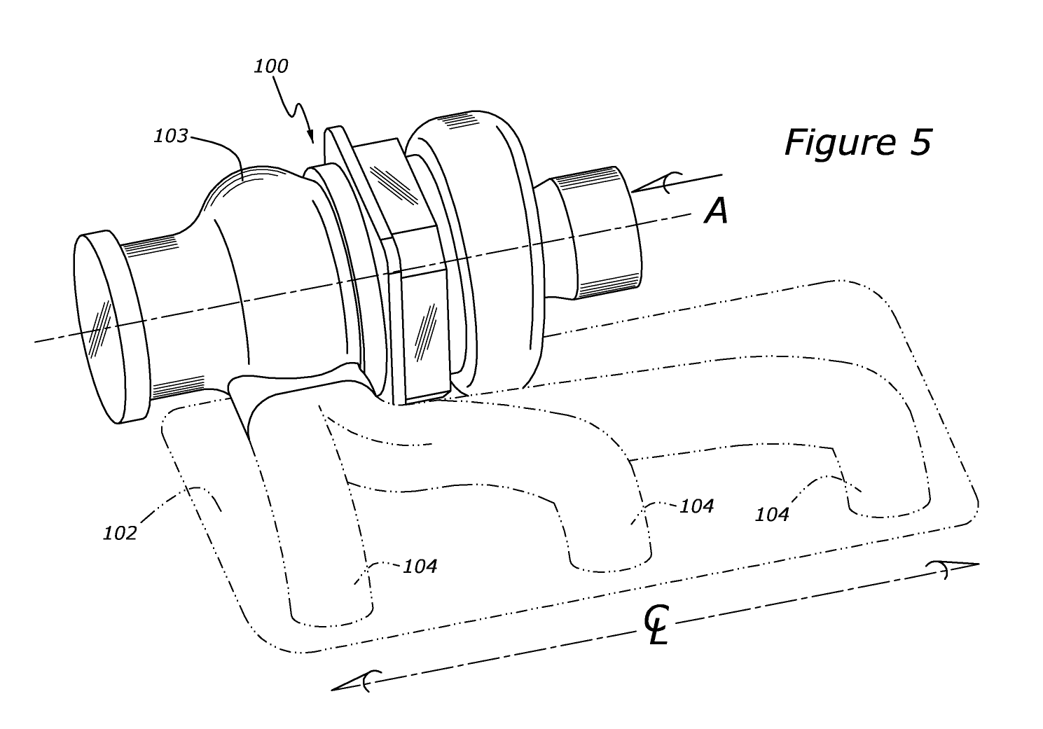

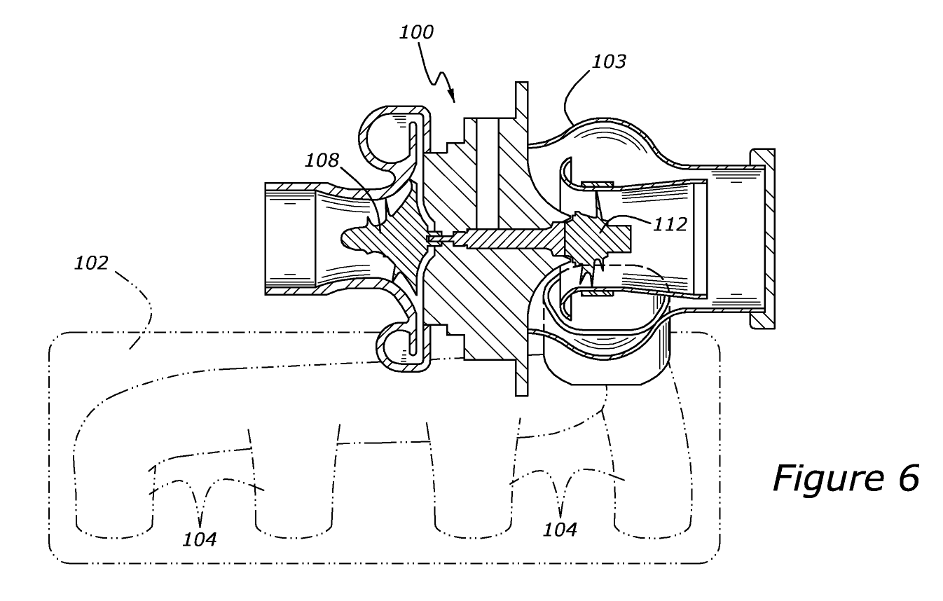

FIG. 5 shows a turbocharger hot side, 103, which is one-piece with a cylinder head, 102, including exhaust runners 104. Turbocharger 100, including hot side 103, has a centerline, A, which is parallel to an engine centerline C_{L}. FIG. 6 shows internal components of turbocharger 100 such as exhaust turbine 112 located within hot side 103, and compressor wheel 108.

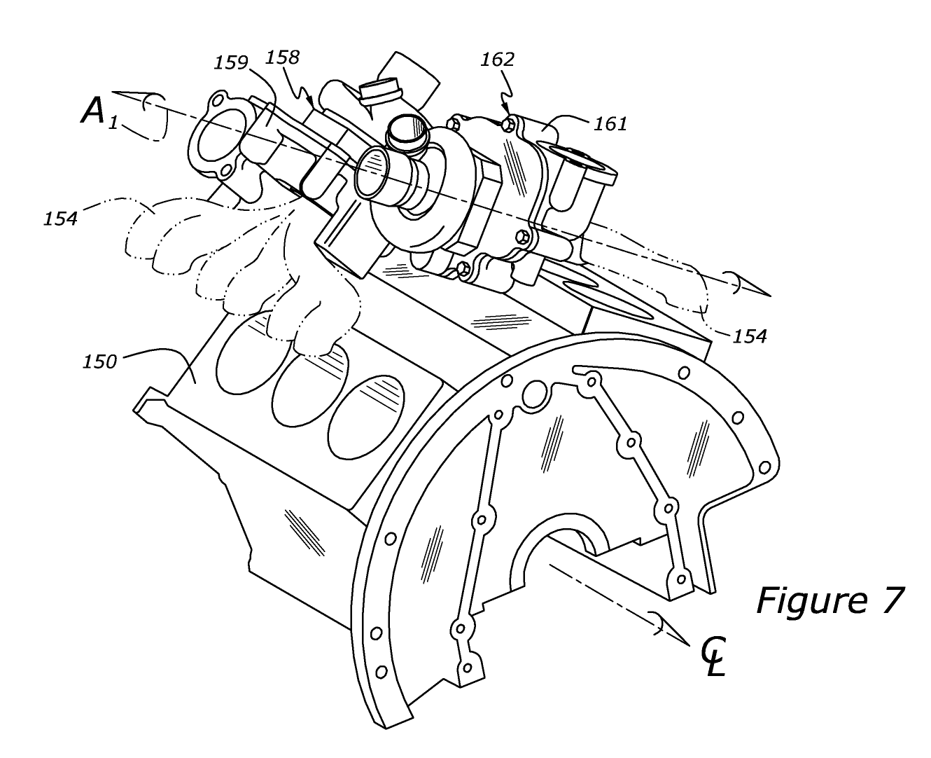

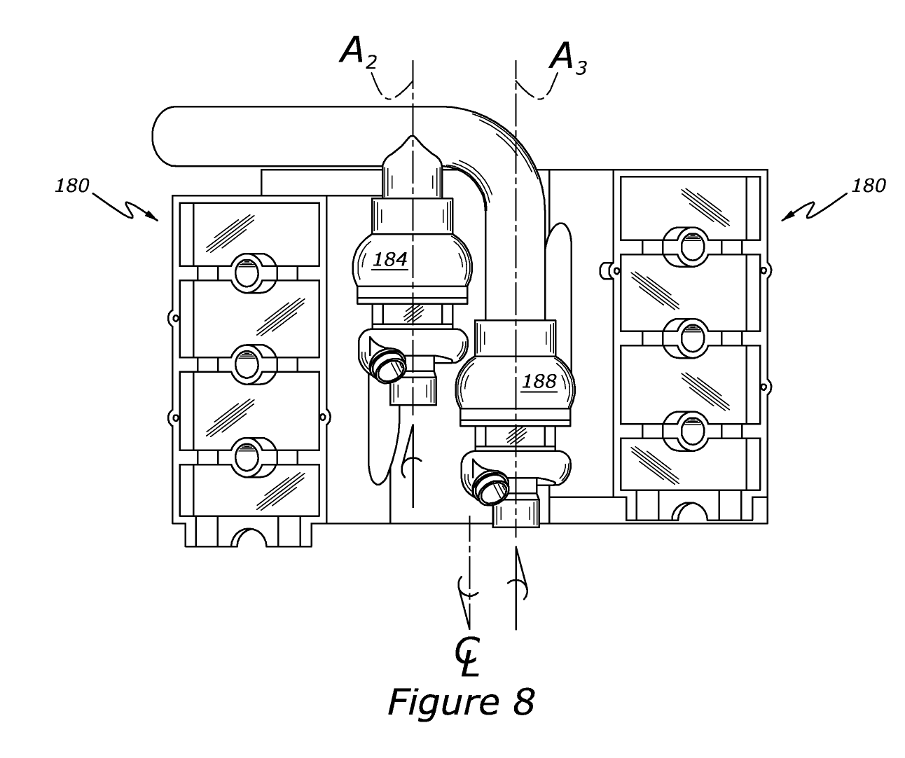

FIGS. 7 and 8 show two V-engine configurations of a system according to the present disclosure in which two turbochargers are mounted in the valley defined by the V-block and cylinder heads. FIG. 7 shows a V-block, 150, and two turbochargers, 158 and 162, having hot sides 159, and 161, respectively, which are one piece with exhaust runners, 154, as well as the remaining portions of the cylinder heads (not shown). Turbochargers 158 and 162 have centerlines (one shown at A₁) which are perpendicular to the centerline, C_{L}, of cylinder block 150. In the embodiment of FIG. 8, however, which also features one-piece construction, turbocharger hot sections 184 and 188 are one-piece with respective cylinder heads 180, and the central axes, as shown at A₂ and A₂ are parallel to centerline C_{L} of the engine.

The foregoing system has been described in accordance with the relevant legal standards, thus the description is exemplary rather than limiting in nature. Variations and modifications to the disclosed embodiments may become apparent to those skilled in the art and fall within the scope of the disclosure. Accordingly, the scope of legal protection can only be determined by studying the following claims.

What is claimed is:

1. An internal combustion engine, comprising:
a plurality of power cylinders;
a cylinder head attached to said power cylinders, with said cylinder head comprising:
a plurality of exhaust runners conducting exhaust gases from the power cylinders;
an exhaust collector merging exhaust gases flowing through said plurality of exhaust runners; and
an integral turbocharger turbine housing extending through a wall of said exhaust collector.

2. An internal combustion engine according to claim 1, further comprising an exhaust turbine located within said integral turbocharger turbine housing.

3. An internal combustion engine according to claim 1, wherein said cylinder head further comprises:
an exhaust turbine located within said integral turbine housing; and
a charge air compressor coupled with said exhaust turbine upon a common rotating shaft.

4. An internal combustion engine according to claim 1, wherein said cylinder head further comprises a wastegate located within the cylinder head and controlling the pressure of exhaust gas within said exhaust collector.

5. An internal combustion engine according to claim 1, wherein said cylinder head further comprises a liquid coolant passage extending about an outer periphery of said turbine housing, with said liquid cooling passage being connected with at least one other cooling passage located within the cylinder head.

6. An internal combustion engine according to claim 1, wherein said cylinder head is configured as a one-piece structure comprising said exhaust runners, said exhaust collector, and said turbocharger turbine housing.

7. An internal combustion engine according to claim 6, wherein said one-piece structure comprises a metallic casting.

8. An internal combustion engine according to claim 7, wherein said metallic casting comprises an aluminum casting.

9. An internal combustion engine according to claim 7, wherein said metallic casting comprises a ferrous casting.

10. An internal combustion engine according to claim 1, wherein said exhaust turbine comprises a forward facing axial flow turbine.

11. An internal combustion engine, comprising:
a plurality of power cylinders;
a cylinder head attached to said power cylinders, with said cylinder head configured as a one-piece base structure comprising:
a plurality of exhaust runners conducting exhaust gases from the power cylinders;
an exhaust collector merging exhaust gases flowing through said plurality of exhaust runners; and
an integral turbine housing extending through a wall of said exhaust collector.

12. An internal combustion engine according to claim 11, wherein said cylinder head further comprises:
an exhaust turbine rotatably mounted within said integral turbine housing;
a compressor housing attached to said integral turbine housing; and
a charge air compressor located within said compressor housing, with said charge air compressor being coupled with said exhaust turbine upon a common rotating shaft.

13. An internal combustion engine according to claim 12, wherein said exhaust turbine comprises a forward facing axial flow turbine.

14. A cylinder head according to claim 11, wherein said one-piece base structure comprises a metallic casting.

15. A cylinder head for a multicylinder internal combustion engine, comprising a one-piece structure having:
a cylinder closure portion enclosing the upper ends of a plurality of power cylinders;
a plurality of exhaust runners extending from said cylinder closure portion, with the exhaust runners conducting exhaust gases from the power cylinders;
an exhaust collector merging exhaust gases flowing through said plurality of exhaust runners;
an integral turbocharger turbine housing formed in a wall of the exhaust collector, with said integral turbocharger turbine housing extending through a wall of said exhaust collector; and
a turbocharger exhaust outlet configured to conduct exhaust gases flowing from the turbine housing to an exterior portion of the cylinder head.

16. A cylinder head according to claim 15, wherein said one-piece structure comprises a metallic casting.

17. A cylinder head according to claim 16, wherein said metallic casting comprises a ferrous casting.

18. A cylinder head according to claim 16, wherein said metallic casting comprises an aluminum casting.

19. A cylinder head according to claim 15, further comprising a forward facing axial flow turbine.

20. A cylinder head according to claim 15, wherein said cylinder head is mounted upon a v-block engine, with said turbocharger turbine housing being configured so that the central axis of a turbocharger incorporating said turbine housing is perpendicular to the centerline of the engine and the turbocharger is located in the valley area of the engine.

21. A cylinder head according to claim 15, wherein said cylinder head is mounted upon a v-block engine, with said turbocharger turbine housing being configured so that the central axis of a turbocharger incorporating said turbine housing is parallel to the centerline of the engine and the turbocharger is located in the valley area of the engine.
